(19) United States
(12) Patent Application Publication
(10) Pub. No.: US 2012/0037084 A1
(43) Pub. Date: Feb. 16, 2012

(54) HOOF WASHING SYSTEM AND METHOD

(75) Inventors: Peter Thorup Thomsen, Moldrup (DK); Tom Bruhn Pedersen, Ringkobing (DK)

(73) Assignees: AQUA CLEANER V/TOM BRUHN PEDERSEN, Ringkøbing (DK); AARHUS UNIVERSITET, Åarhus C (DK)

(21) Appl. No.: 13/139,991

(22) PCT Filed: Dec. 15, 2009
(86) PCT No.: PCT/DK2009/050338

§ 371 Date: Sep. 28, 2011

(30) Foreign Application Priority Data
Dec. 16, 2008 (DK) PA 2008 01786

(51) Int. Cl. A01K 13/00; A01K 29/00

(52) U.S. Cl. 119/651; 119/667

(57) ABSTRACT

In order e.g. to obtain an effective washing system which provides effective treatment for treating hoof diseases there is disclosed a hoof washing system (102) including a floor surface (202), and a plurality of animal guides (106), and at least one sensor (108) for sensing a presence of the animal in or adjacent to the washing system, and at least one jet sprayer (204). The floor surface comprises flow providing means so as to provide a downward or sideways flow (602, 402) of washing liquid out of the system. The jet sprayer is arranged so as to provide a jet of the washing liquid parallel with the traffic direction (104) towards at least one hoof (708) and the lower part (702) of at least one animal leg, and the system further comprises speed limiting means (214, 306, 308, 802) so as to limit a traffic speed of the animals through the washing system.

### FIELD OF THE INVENTION

The invention relates to a hoof washing system for washing the hooves of an animal, and in particular to a hoof washing system for preventing and/or curing hoof diseases or inflammation. The present invention may be used for many kinds of animals with hooves, but is explained in connection with cows.

### BACKGROUND OF THE INVENTION

Contagious hoof diseases among cows are a substantial problem. The problem may among others lie therein that the diseases reduces a production capacity and well being of the cow. An antibiotic treatment may influence a production of dairy products and e.g. make it impossible to produce cheese from milk taken from the cow treated with antibiotics. Thus, milk from a cow treated with antibiotics can not be sent to a diary production facility.

Other forms of treatments of the animals known to the present inventors may e.g. use a considerable amount of liquid, interfere in an inexpedient way with cow traffic and/or fail to provide a treatment which has an effect in order to prevent or treat the diseases.

The inventor of the present invention has in consequence appreciated that an improved washing system and method is of benefit, and has in consequence devised the present invention.

### SUMMARY OF THE INVENTION

It may be seen as an object of the present invention to provide an improved hoof washing system for washing the hooves of an animal and an improved method of washing the hooves of an animal in a washing system. Preferably, the invention alleviates, mitigates or eliminates one or more of the above or other disadvantages singly or in any combination.

In particular, it may be seen as an object of the invention to provide a hoof washing system and a hoof washing method which interferes minimally with cow traffic while providing an effective treatment in order to prevent and/or treat hoof diseases.

Accordingly there is provided, in a first aspect, a hoof washing system for washing the hooves of an animal, the washing system comprising
a floor surface, and
a plurality of animal guides, and
at least one sensor for sensing a presence of the animal in or adjacent to the washing system, and
at least one jet sprayer for spraying at least one jet of a washing liquid, and wherein
the animal guides are side-guiding the animals in the traffic direction through the washing system, the animal guides being provided in a height or manner to assure that the animals only enter and leave the system in the traffic direction, and
the jet sprayer is arranged so as to provide a jet of the washing liquid parallel with the traffic direction towards at least one hoof and a lower part of at least one animal leg, in response to a signal from the sensor, and the system further comprises speed limiting means so as to limit a traffic speed of the animals through the washing system.

Thus an improved hoof washing system for washing the hooves of an animal is provided. The improvement or advantage may lie therein that when providing a washing system as described a washing system which interferes minimally with cow traffic while providing an effective treatment in order to prevent and/or treat hoof diseases is provided. The overall improvement may lie in a synergetic effect between a number of means, effects or advantages.

A possible advantage by arranging the jets as described is that the direction of the jets enables cleaning of areas that may be infected. Furthermore by providing jets, any dirt covering infected areas is removed and the actual infection is then at least cleaned. The jet sprayer may spray in a direction which is both forward and rearward parallel with the traffic direction, though it is possibly preferred that the jets sprayers is only arranged so as to provide one or more jets in the traffic direction.

When providing speed limiting means as described, a possible advantage is that an average moving speed of a relatively slowly walking animal may not be changed when the animal moves through the system. On the other hand, an average moving speed of a relatively fast moving animal will be limited towards the average speed of the relatively slowly walking animal. Still further the speed limiting means allows an animal to move forward continuously, in that a gate or the like means are not locked in the traffic direction, but the speed limiting means is only e.g. an obstacle, such as a removable obstacle, which the animal will notice and therefore the animal will slow down to a limited speed and e.g. not be forced to stop. A possible advantage hereby is that cow traffic in a modern cow stable where a relatively high number of cows move in a certain traffic pattern is not interfered with or any interference is minimised.

In that the lower part of the animal leg and the hoof is now clean, a possible advantage and possible additional advantageous feature is that the washing system may be followed by a hoof bath where the animal steps into a bath with a level of water with additives in. In order to assure that no cross contamination takes place in the bath and/or that no inactivation of the additives in the bath takes place, the level of water should be adapted so that preferably maximum the clean lower part of the animal leg is inserted in water.

When the floor surface comprises flow providing means so as to provide a downward flow of washing liquid down through the floor and/or adapted to provide a sideways flow of washing liquid out of the washing system sideways to a traffic direction, a possible advantage is that any dirt or manure removed of the at least one animal leg and of the at least one animal hoof as well as used washing liquid, is flushed directly out through the floor or directly out through the system in a sideways direction relative to the traffic direction. Here ‘directly’ is to be understood as with a minimum distance towards a way out of the system'. Hereby a possible advantage is that a risk of cross contamination of the animals, or even between animal legs, is minimised in that any debris of dirt or like and used washing liquid is removed or flushed as quickly and directly as possible, preferably during washing of each individual animal. Additionally a possible advantage is that hereby no manual cleaning is possibly necessary.

When the speed limiting means comprises one or more of the following means; one or more additional animal guides forcing the animal to change traffic direction within or relatively short after the washing device, an angled floor surface, a declining floor surface, an inclining floor surface, width between two animal guides, width and/or height of a centre member with an elevated surface, a narrow row of floor surface arranged in each side of the washing system, one or more flashing lights, traffic obstacles, movable traffic obstacles, removable traffic obstacles, a possible advantage is that relatively simple but effective speed limiting means are provided.

When the speed limiting means used changes from time to time or changes position from time to time, a possible advantage is that the animal may not be accustomed to a given speed limiting means or position.

When the flow providing means comprises one or more of the following means; a floor surface provided with openings for letting the washing liquid run through so as to be able to flush the floor surface through the openings with the washing liquid, the floor comprises one or more surfaces angled in order to provide a sideways flow, a sideways convex floor surface, sideways openings along the floor surface, a perforated floor surface, a possible advantage is that that relatively simple but effective flow providing means are given. Alternatively or additionally, the floor surface inside the washing system declines towards the exit of the system so as to provide or increase a forward flow of washing liquid. This may be provided by tilting the floor surface inside the washing system slightly, such as 5-10 degrees, and i.e. have a floor surface height at the entrance which is slightly higher than at the exit.

When the jet sprayer is arranged to provide a jet of washing liquid in a direction substantially parallel with the floor surface, a possible advantage is that it is directed towards a possible infected area independently of a distance from a jet sprayer to an animal leg. Still further a possible advantage is that contamination of an udder of the animal is prevented in that the washing liquid or any debris removed from the animal will be directed in the traffic direction and as fast as possible out of the system—and not upwardly towards the udder.

When the system further comprises means for providing one-way traffic or the speed limiting means include these means, a possible advantage is that cows only enter in one end.

When the washing liquid is clean water, a possible advantage is that any cross contamination in recycled water is prevented. The clean non recycled water may possibly be provided with an additive or the system may be provided with a separate liquid forwarding system in which the liquid is provided with an additive. The liquid provided with an additive may then be sprayed out of the jet sprayers or out of separate jet sprayers after any dirt is removed from the animal legs and hooves.

When the at least one jet sprayer sprays in response to movement detected by the sensor, a possible advantage is that less water may be used.

When the at least one jet sprayer is arranged so as only to spray in the traffic direction, a possible advantage is that less water is used while an effective cleaning is still obtained.

In accordance with a second aspect of the invention there is provided a method of washing the hooves of an animal in a washing system, the washing system, comprising a plurality of side guides, a floor surface, and at least one sensor, and at least one jet sprayer, the method comprising
guiding the animals within the washing system and hereby assuring that the animals only enter and leave the system in the traffic direction,
sensing a presence of an animal in or adjacent to the washing system,
limiting a traffic speed of the animals through the washing system,
washing the animals by providing at least one jet of the washing liquid in the traffic direction in response to a signal from the sensor.

It is to be understood that the invention is particularly, but not exclusively, advantageous for obtaining a mentioned advantage. In general the various aspects and advantages of the invention may be combined and coupled in any way possible within the scope of the invention.

These and other aspects, features and/or advantages of the invention will be apparent from and elucidated with reference to the embodiments described hereinafter.

### BRIEF DESCRIPTION OF THE DRAWINGS

Embodiments of the invention will be described, by way of example only, with reference to the drawings, in which

FIG. 1 shows a side view of the washing system 102.

FIG. 2 is a top view of the washing system, and

FIG. 3 is a view in a traffic direction along a line A-A as indicated on FIG. 1, and

FIG. 4 is an illustration of a cross section along a line B-B as indicated on FIG. 1, and

FIG. 5 is an illustration of a cross section along a line C-C as indicated on FIG. 1, and

FIG. 6 is an illustration of a cross section along a line D-D as indicated on FIG. 1, and

FIG. 7 is a close-up view in a traffic direction of a lower part of a leg of an animal, and

FIG. 8 is an illustration of how to provide speed limiting means by forcing an animal to change traffic direction.

### DESCRIPTION OF EMBODIMENTS

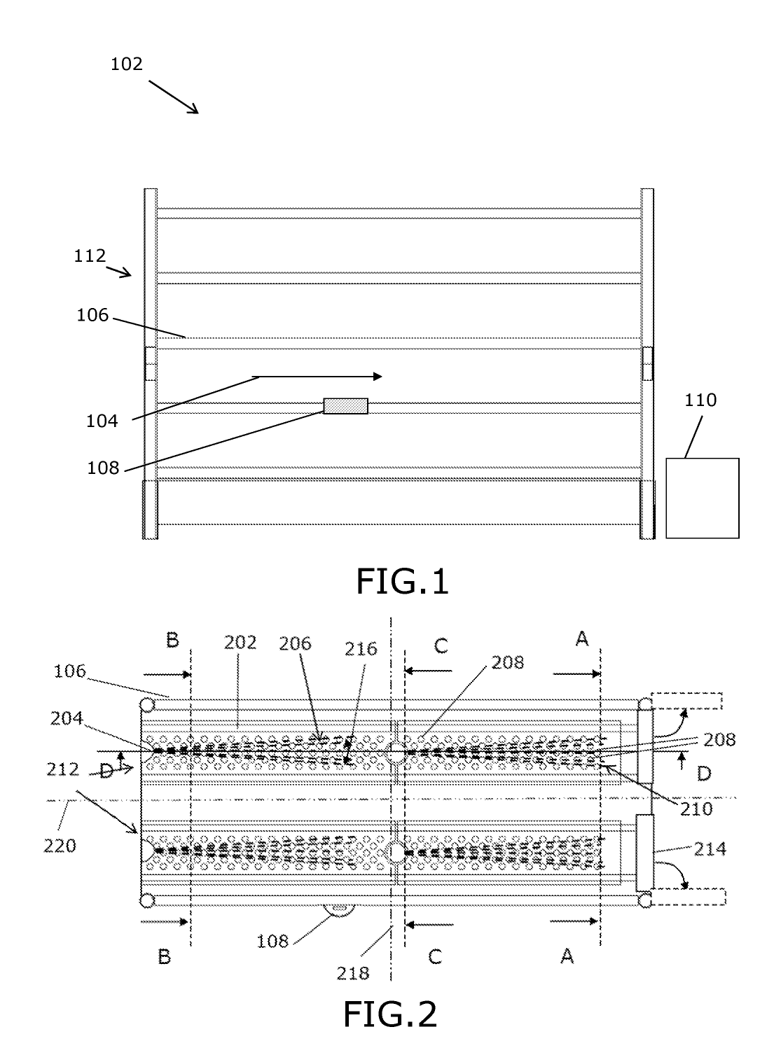

FIG. 1-3 illustrates a hoof washing system 102 for washing the hooves of an animal such as a cow. The figures show that the system includes a floor surface 202 and a plurality of animal guides 106. In the shown example there are five guides 106 on each side of the washing system distributed in height and forming a frame-like structure. The animal guides 106 are side-guiding the animals in the traffic direction 104 through the washing system. In the shown embodiment the animal guides 106 are connected to the floor surface, though the animal guides may alternatively or additionally be provided by one or more walls adjacent to the device or one or more separate members (not shown). Inside the washing system 102 there is provided a sensor 108 for sensing an animal in the washing system. The sensor is shown to be positioned on one side of the washing system in a distance from an entrance end 112 and in a distance above the floor surface 202.

The washing system is equipped with four jet sprayers 204 for spraying jets 206 of washing liquid in the traffic direction 104. A spraying angle in a horizontal plane of approximately 15 degrees of the jets is indicated at 216. The jets are sprayed in response to a signal from the sensor by applying pressure to a washing liquid with a pressure providing device 110. The pressure providing device provides washing liquid under pressure to the jet sprayers 204 via suitable hoses or tubes (not shown). The shown jet sprayers are arranged to provide a jet of the washing liquid only in the traffic direction, and e.g. not perpendicular to the traffic direction. The flow (not the jets) of liquid may preferably be perpendicular to the traffic direction, downward or sideward, but this is after the jets have hit the animal leg or hoof.

It has been found that cleaning with only two forward directed jet sprayers 204 at the entrance end provides a suitable cleaning while possibly saving washing liquid when compared to e.g. four or more jet sprayers 204. In consequence, the washing system 102 may only be provided with two forward spraying jet sprayers 204 at the entrance end 112, one jet sprayer in the middle or substantially in the middle of each the narrow rows 212.

The washing liquid supplied to the washing system via the pressure providing device 110 is clean, non-recycled tap water. One or more minor amounts of disinfectants or other additives may though possibly be added to the water. The floor 202 in the washing device 102 is constituted by two narrow rows 212 of floor surface 202. The floor surface is provided with openings 208 in order to obtain a downward flow of washing liquid down through the floor surface 202 in the washing system 102.

Most of the floor surface 202 includes a pattern with holes or openings 208 all the way through the surface for flushing or discharging manure all the way through the floor surface. Other patterns may be provided and alternatively or additionally to the holes there may be used slots all the way through the floor surface. The floor surface is provided for preventing the animals from slipping on the floor surface and in this example also for flushing or washing the washing device and providing a downwards flow of washing liquid.

The washing device in the shown embodiment has a length of approximately 2500 mm. and a width of approximately 900 mm. The width between the side-guides is adjustable, e.g. by providing prefabricated members to be fixed inside the washing device along the animal guides in each side in order to centre a smaller animal in the device and/or to assure that such an animal does not move too fast within the device. A washing time for each animal, i.e. a time for each animal to move through the washing system is approximately between 3 and 10 seconds. Such washing time is found to be appropriate to have an effective washing system while also not interfering with cow traffic in e.g. a milking system.

The washing system may be equipped with heating means (not shown), or anti freezing means, so as to prevent water or dirt particles in or on the system from freezing and thereby being stuck in or on the system. The heating means may e.g. be electrical heating means incorporated in various parts of the system and/or a heating system based on water.

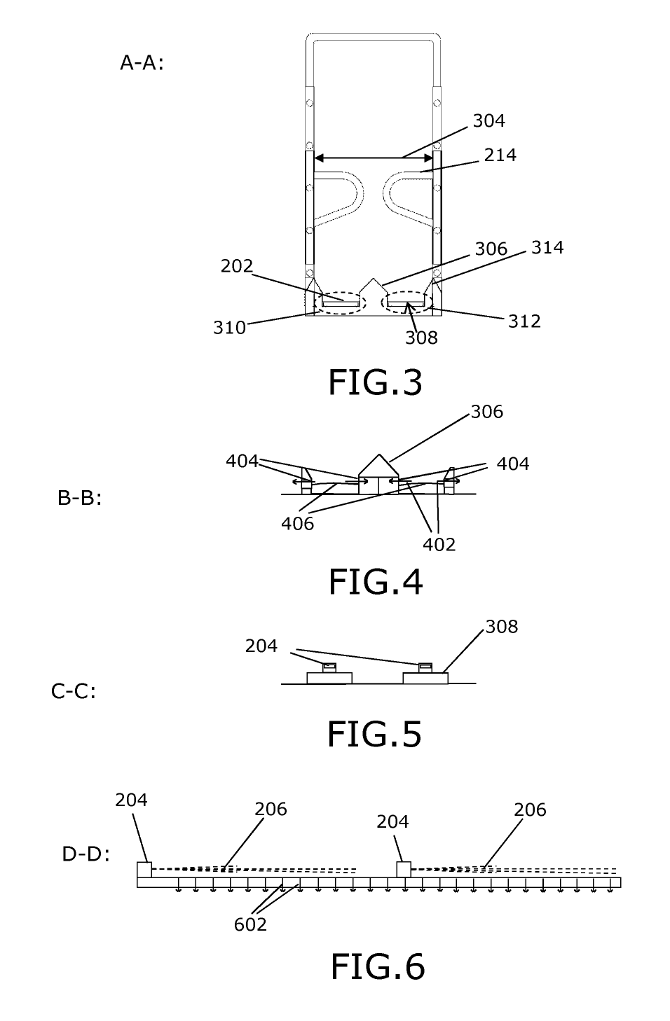

In FIG. 3 there is shown a removable obstacle 214 in the form of a gate member on each side of the frame structure of the washing device. In the shown example the gate only opens upon a force applied from an animal moving in the traffic direction. The gate is not locked in the traffic direction and can be opened solely by a moving cow. The gate is locked from opening in the other direction and therefore also serves as a means for providing one-way traffic. When an animal moves in the traffic direction within the washing device and notices the gate, the gate will limit a speed of movement of the animal, i.e. also serve as a speed limiting device or means. Other speed limiting means may be foreseen, such as providing a width 304, between the animal guides, which width 304 is just as wide as the widest animal using the washing device. A further speed limiting means is illustrated in FIG. 8.

It follows from FIG. 3 that the removable obstacle 214, i.e. ‘the gate’ is provided on the exit side of the washing system.

In order possibly to improve the system further, it is preferred that the entrance is continuously open and does not have any gate as shown in the figures. This has the possible advantage that if a cow does not move very fast through the washing system (or even stops ‘too long’ relative to usual cow speed) a cow just behind it in the cow traffic line may enter the washing system and bump into the ‘rather slow’ cow. The rather slow cow is then able to move out of the washing system in that the exit gate or other speed limiting means on the exit side is only ‘speed limiting’ (i.e. not locked in the traffic direction or solely includes a sharp turn after the washing system) and thus can be opened or walked trough by ‘the slow cow’, and thus the ‘slow cow’ can move out of the system.

Therefore cow traffic is enabled by the open entrance and the speed limiting means, such as the removable obstacle 214, or the other mentioned speed limiting means (such as only a turn on the exit side) to flow properly, relatively non-interfered and relatively continuously. This is especially seen when compared with reference systems where cows are locked inside a system with exit and/or entrance gates that are closed and locked for e.g. 5-10 or even 30 seconds. A synergetic effect of this is that a (relative slowly) moving cow, that shifts position of its legs and hooves a plurality of times in the washing system, is also cleaned in an improved way, e.g. when compared to a cow which is forced to be in a more or less fixed position 5-10 or more seconds.

FIG. 2 is a top view of the washing system. It is shown that adjacent to the entrance end there is positioned a jet sprayer 204 approximately in the middle of each of the two narrow rows 212 of the floor surface 202. Similarly there is positioned a jet sprayer 204 approximately in the middle of each of the two narrow rows 212 midways through the washing device. Possibly there are more sets of jet sprayers positioned along a length of the floor surface (not shown).

In the shown embodiment the jet sprayers only spray in the traffic direction 104. In practice it has been found that this is enough to clean both a back side and a front side of the animal legs and hooves. This may be due to that when the washing liquid hit the back side of the animal legs the liquid also flows to the front side of the leg. A possible advantage by only spraying in the traffic direction 104, and e.g. not both in the traffic direction and directly oppositely the traffic direction, is that the jets does not hit each other and create water splashes in all directions, such as in a direction of the udder of the animal. Additionally, fewer jets will mean less water consumption.

The jet sprayer may spray in a direction which is both forward and rearward parallel with the traffic direction.

FIG. 3 is a view in a traffic direction along a line A-A as indicated on FIG. 1. The figure shows the narrow row 308 in a right side 312 and a left side 310 of the washing device. The figure also shows a centre member 306 with an elevated surface being positioned between the two narrows rows in each side. The elevated centre member is provided as described in order to assure that an animal position a left and right side leg on each side of the centre member 306 and not both a left and right side leg on one side of the washing system. Side members 314 in each outer side of the washing device are also shown.

An upper surface of the centre member and the side members is angled in order to assure that the animal positions the legs in the two narrow rows between the centre member and the side members 314. The angled surfaces and the width of the side members and the centre member is e.g. provided in order to assure that the legs are positioned relative precisely aligned with the jets 206 and possibly also to assure that the animals are not able to achieve a speed above “a speed limit”. A possible advantage hereby is that a quality of a washing result is improved e.g. relatively to a ‘wide’ washing system without narrow rows where the animals are able to walk relatively fast or even run through the washing system.

Still further, a possible advantage by the washing system as described and particularly by the centre member, which centre member is preferably higher than approximately 0.1 meter, and/or by the two narrow rows (one row in each side as described) and/or by the position of the jet sprayers and/or by the relative narrow animal guides is that such one or more features provides a relative continuous, ‘not to fast’ (i.e. no fast running cows) and ‘not to slow’ (no cows held back, forced to stop or prevented from entering or exiting the system) flow of cows through the washing system.

Furthermore a flow of cows is provided where or while a position of the hooves or each hoof of the cow will tend to be shifted at least 2-3 times when the cow is moving trough the washing system.

FIG. 4 is an illustration of a cross section along a line B-B as indicated on FIG. 1. The figure shows that a sideways flow 402 of washing liquid out of the washing system sideways to the traffic direction is provided via openings 404 in the centre member 306 and in the side member 314. Furthermore the figure shows that each of the narrow floor surface rows are provided with a convex surface 406 in order to improve the sideways flow of washing liquid. A possible advantage hereby is that the washing device is cleaned or flushed from any manure or the like loose parts from the animal laying on the floor surface. This may preferably take place during washing of the animals and/or alternatively or additionally in a short time frame between each individual animal in a traffic line of animals entering the washing device.

FIG. 5 is an illustration of a cross section along a line C-C as indicated on FIG. 1 and towards an opening of jet sprayer 204. For simplicity only the two narrow rows 308 of floor surface 202 and the jet sprayer are shown in the figure. The opening of the jet sprayer is positioned approximately 0.03 meters above the floor surface 202 of the washing device. The opening is in the shown example rectangular with a width of approximately 10 mm. and a height of approximately 0.7 mm. With an appropriate pressure of liquid such as approximately 15 bar or 1.5 Mega-Pascal this form and area of the jet sprayer nozzle gives a horizontal spraying angle of approximately 15 degrees and less than 5 degrees spreading of the washing liquid in a vertical direction. The 15 degrees of horizontal angle 216 is indicated in the top view on FIG. 2. A rear most set of jet sprayers adjacent to the entrance may provide a somewhat larger amount of washing liquid than a front most set of jet sprayers in the middle of the washing system in that the rear legs of the animal tend to be more encapsulated in dirt than the front most legs.

The jet sprayers 204 may be provided with a cover (not shown) at least covering the jet sprayer in order to prevent the jet sprayers from being damaged by the animals and for preventing the animals from injury. The cover for a jet sprayer may also be provided so as to be an obstacle on the floor surface which the animal must move over and therefore a cover, or a box like structure on the floor, may also be a speed limiting means. The cover may also be provided so that the jet from the jet sprayer is somewhat spread before it leaves the cover.

When providing covers approximately midways through the washing device which covers forms a barrier between a front and a rear part of the washing device a possible advantage is that cross contamination, in the washing device, between front and rear legs of the animal may be eliminated or reduced. When not spraying sideways in the washing device and/or when proving a member such as the centre member 306 as a barrier in a lengthwise direction of the washing system, cross contamination, within the washing device, between left and right side legs of the animal, may possibly be eliminated or at least reduced. In a possible embodiment (not shown in detail, though barriers are indicated in FIG. 2) the washing device may therefore include a first barrier 220 approximately in the middle of the washing device in a sideways direction and possibly also one or more second barriers 218 in the traffic direction, approximately midways through the washing device. The covers may be arranged and provided in a structural way so as to obtain one or more second barriers 218 and the centre member 306 may be arranged and provided in a structural way so as to obtain the first barrier 220.

FIG. 6 is an illustration of a cross section along a line D-D as indicated on FIG. 1. Here the jet sprayers and the horizontal or slightly downwardly extending jets 206 are shown in a side-view. From the figure it can also be seen that the floor surface includes openings or the like in order to provide a downward flow 602 of washing liquid and any dirt down through the floor surface of the washing device.

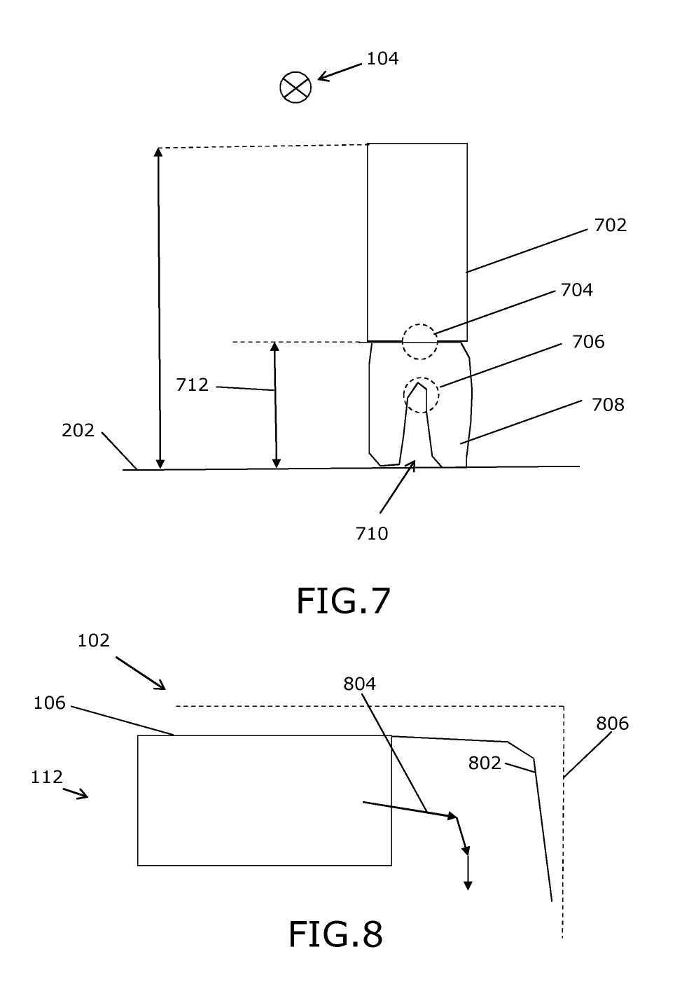

FIG. 7 shows a close-up view of a lower part 702 of a leg of an animal positioned in the washing device. The view is seen in the traffic direction 104 of the washing device. The figure shows the animal hoof 708 extending from the lower part 702 of the animal leg. An interdigital cleft 710 in the hoof 708 is shown. The interdigital cleft 710 extends substantially parallel with the traffic direction and narrows down in an upward direction. In the area indicated with the circle 706 a inflammation of the interdigital cleft of the animal is usually present. On a backside of the leg in an area 704 bridging the lower part of the leg and the hoof digital dermatitis is usually present. When the animal stands on the surface a transition between the hoof and the lower part of the leg is positioned in a distance 712 above the surface 202. This distance is approximately 3-10 cm above the floor surface. The present washing system is among others provided in order to wash the lower part of the leg and the hooves of the animals in order to prevent these diseases such as the described to occur and/or to cure them.

FIG. 8 shows the washing system 102 with the animal side guides 106 and the entrance end 112. It follows from the figure that towards an exit end of the washing system 102 an additional animal guide 802 is provided for forcing the animal to change traffic direction. The changed traffic direction is illustrated with the arrows 804, which are not in the traffic direction. The change of direction is performed within the washing system, in a last part of the washing system, and/or just after exit of the washing system.

An alternative to fixing an additional animal guide 802 on the washing system or in conjunction with the washing system is to position the washing system with an exit end approximately 1 meter from a wall 806 so that the animal is forced to change traffic direction when or just after exiting the washing system 102. When the animal guide 802 is provided as described or the washing system is positioned as described the animal guide 802 or the wall 806 will function as a speed limiting means.

In general the floor surface is adapted in dependence of e.g. the amount of spraying liquid so as to make the washing system self cleaning or self flushing while at the same time washing the animals moving through the system. In the shown system there is used approximately 2-5 litre per animal, more specifically 3-4 litre washing liquid per animal and the washing time is approximately between 3 and 10 seconds, and preferably around 5 seconds per animal.

Although the present invention has been described in connection with preferred embodiments, it is not intended to be limited to the specific form set forth herein. Rather, the scope of the present invention is limited only by the accompanying claims.

In this section, certain specific details of the disclosed embodiment are set forth for purposes of explanation rather than limitation, so as to provide a clear and thorough understanding of the present invention. However, it should be understood readily by those skilled in this art, that the present invention may be practised in other embodiments which do not conform exactly to the details set forth herein, without departing significantly from the spirit and scope of this disclosure. Further, in this context, and for the purposes of brevity and clarity, detailed descriptions of well-known apparatus, circuits and methodology have been omitted so as to avoid unnecessary detail and possible confusion.

In short it is herein disclosed that in order e.g. to obtain an effective washing system which provides effective treatment for preventing and/or treating hoof diseases there is provided a hoof washing system 102 including a floor surface 202, and a plurality of animal guides 106, and at least one sensor 108 for sensing a presence of the animal in or adjacent to the washing system, and at least one jet sprayer 204. The floor surface comprises flow providing means so as to provide a downward or sideways flow 602, 402 of washing liquid and any dirt out of the system. The jet sprayer is arranged so as to provide a jet of the washing liquid parallel with the traffic direction 104 towards at least one hoof 708 and a lower part 702 of at least one animal leg, and the system further comprises speed limiting means 214 so as to limit a traffic speed of the animals through the washing system.

In the claims, the term “comprising” does not exclude the presence of other elements or steps. Additionally, although individual features may be included in different claims, these may possibly be advantageously combined, and the inclusion in different claims does not imply that a combination of features is not feasible and/or advantageous. In addition, singular references do not exclude a plurality. Thus, references to “a”, “an”, “first”, “second” etc. do not preclude a plurality. Reference signs are included in the claims however the inclusion of the reference signs is only for clarity reasons and should not be construed as limiting the scope of the claims.

1. A hoof washing system for washing the hooves of an animal the washing system comprising:
a floor surface, and
a plurality of animal guides, and
at least one sensor for sensing a presence of the animal in or adjacent to the washing system, and
at least one jet sprayer for spraying at least one jet of a washing liquid, and wherein
the animal guides are side-guiding the animals in the traffic direction through the washing system, the animal guides being provided in a height or manner to assure that the animals only enter and leave the system in the traffic direction, and
the jet sprayer is arranged so as to provide a jet of the washing liquid parallel with the traffic direction towards at least one hoof and a lower part of at least one animal leg in response to a signal from the sensor, and the system further comprises speed limiting means so as to limit a traffic speed of the animals through the washing system.

2-17. (canceled)

18. A hoof washing system according to claim 1, wherein the speed limiting means comprises one or more of the following means; one or more additional animal guides for forcing the animal to change traffic direction within or relatively short after the washing device, an angled floor surface, a declining floor surface, an inclining floor surface, width between two animal guides, width of a centre member with an elevated surface, a narrow row of floor surface arranged in each side of the washing system, one or more flashing lights, traffic obstacles, movable traffic obstacles, or removable traffic obstacles.

19. The hoof washing system according to claim 1, wherein the speed limiting means used changes from time to time.

20. The hoof washing system according to claim 1, wherein the floor surface comprises a flow providing means so as to provide a downward flow of washing liquid down through the floor and/or adapted to provide a sideways flow of washing liquid out of the washing system sideways to a traffic direction.

21. The hoof washing system according to claim 20, wherein the flow providing means comprises one or more of the following means; a floor surface provided with openings for letting the washing liquid run through so as to be able to flush the floor surface through the openings with the washing liquid, the floor comprises one or more surfaces angled in order to provide a sideways flow, sideways openings along the floor surface, a sideways convex floor surface, or a perforated floor surface.

22. The hoof washing system according to claim 1, wherein the at least one jet sprayer is arranged to provide a jet of washing liquid in a direction parallel with the floor surface.

23. The hoof washing system according to claim 1, wherein the system further comprises a means for providing one-way traffic or the speed limiting means includes these means.

24. The hoof washing system according to claim 1, wherein the washing liquid is clean water.

25. The hoof washing system according to claim 1, wherein the system further comprises a pressure providing device for providing washing liquid under pressure.

26. The hoof washing system according to claim 1, wherein the at least one jet sprayer sprays in response to movement detected by the sensor.

27. The hoof washing system according to claim 1, wherein the at least one jet sprayer is arranged so as only to spray in the traffic direction.

28. The hoof washing system according to claim 1, wherein an entrance to the washing system is open and the animals can freely enter the washing system.

29. A method of washing the hooves of an animal in a washing system, the washing system comprising:
a plurality of side guides, and
a floor surface, and
at least one sensor, and
at least one jet sprayer,
the method comprising
guiding the animals within the washing system and hereby assuring that the animals only enter and leave the system in the traffic direction,
sensing a presence of an animal in or adjacent to the washing system,
limiting a traffic speed of the animals through the washing system, and
washing the animals by providing at least one jet of the washing liquid in the traffic direction towards at least one hoof and the lower part of at least one animal leg in response to a signal from the sensor.

30. The method of washing the hooves of an animal in a washing system according to claim 29, wherein limiting a traffic speed of the animals through the washing system is provided by forcing the animals to change traffic direction within or relatively short after the washing device.

31. The method of washing the hooves of an animal in a washing system according to claim 29, the method further comprising flushing the floor surface by providing a downward flow of washing liquid down through the floor and/or providing a sideways flow of washing liquid out of the washing system sideways to a traffic direction.

32. The method of washing the hooves of an animal in a washing system according to claim 29, wherein animals are continuously free to enter the washing system in that an entrance to the system is continuously open.

33. The method of washing the hooves of an animal in a washing system according to claim 29, wherein limiting the traffic speed of the animals through the washing system is not preventing the animal from moving out of the washing system.
